(19) United States
(12) Patent Application Publication
(10) Pub. No.: US 2005/0219130 A1
(43) Pub. Date: Oct. 6, 2005

(54) Combination antenna for artillery ammunition

(76) Inventors: Volker Koch, Ruckersdorf (DE); Martin Hertel, Lauf (DE)

Correspondence Address: SCULLY, SCOTT, MURPHY & PRESSER;400 GARDEN CITY PLAZA, GARDEN CITY, NY, 11530, US

(21) Appl. No.: 10/518,332

(22) PCT Filed: Jun. 17, 2003
(86) PCT No.: PCT/EP03/06357

§ 371 Date: Dec. 15, 2004

(30) Foreign Application Priority Data
Jun. 19, 2002 (DE) 102 27 251.4

(51) Int. Cl. H01Q 1/28

(52) U.S. Cl. 343/705; 343/767

(57) ABSTRACT

A slot antenna in the form of an annular disc which can be tuned both to a carrier frequency of satellite systems for navigational purposes and also to a substantially shorter-wave radar frequency for the function of a proximity fuse and which can be subjected to mechanically extreme loadings and is therefore particularly suitable for the fuse of artillery ammunition, has a sandwich structure in which an axially divided resonator ring chamber axially enclosed between upper and lower metallic cover discs profiled to be stable in respect of shape, is provided with a dielectric hollow cylinder which extends with a peripherally extending collar radially opposite the cylindrical reflector wall radially through an axial slot between the two hollow-cylindrical outside walls of the ring chamber to the outer surface of the solid fuse casing which is also peripherally slit. In one of the two cover discs the inner edge of the antenna slot which opens into the ring chamber is defined by a hoop which can be inserted into the front side of the outer wall and on which connecting locations which are displaced relative to each other in the peripheral direction are contacted through the dielectric ring disc and the axially oppositely disposed cover disc to a circuit carrier disc, where they are brought together in single-phase manner by means of a matching network to an antenna line to the high-frequency circuits upstream of the circuits for positional determination and for the function of the radar proximity fuse, the second phase of which is connected to the cover disc adjacent thereto.

The invention concerns an antenna as set forth in the classifying portion of claim 1.

An antenna of that kind is known from DE 100 17 329 A1 in the form of a dielectric carrier disc which is electrically conductively lined on both sides and which is arranged under the fuse cap of the projectile tip in concentric relationship with the longitudinal axis of the projectile. That metallic lining comprises a covering on the front side and a covering on the rear side which extends in all directions between the boundary thereof, thereby affording a funnel-shaped antenna characteristic which is set up forwardly with respect to the transverse plane and which is rotationally symmetrical and which thereby avoids rotation-dependent modulation effects in respect of the high-frequency energy received. Such an antenna as a combination antenna equally replaces there the transmitting and receiving dipole or helix antenna of a radar proximity fuse and the receiving antenna for a satellite navigational device. Tuning of that disc antenna for performing such different tasks in the very different frequency ranges thereof is also effected by way of the dimensioning of the covering to an integral multiple of the resonance frequency, more specifically to the third harmonic of the carrier frequency of a satellite navigational system as the fundamental frequency for the function of the radar proximity fuse so that both systems can be operated by way of this one combination antenna. It will be noted however that, because of the interacting dependency by way of the harmonic, a decoupling effect is required, which is implemented by virtue of the distance radar being brought into operation only in the final phase of target approach, that is to say when the navigational receiver has already been switched off, because in the meantime the projectile has arrived on a corrected trajectory over the target area.

Now, the object of the present invention is to develop a multi-function or combination antenna of that kind, to the effect that the functional dependencies between the radar mode and the navigation mode which hitherto are afforded by way of tuning of the radar antenna to a low multiple of a navigational carrier frequency are at least toned down.

In accordance with the invention that object is attained by the combination of the essential features, which is recited in the main claim. In accordance therewith recourse is structurally essentially made to a slot antenna in accordance with DE 101 36 469 A1, in which an axially divided resonator ring chamber is metallically enclosed axially on both sides in the fuse region. The chamber is of an axial length which is a multiple of the axial thickness of a thin, ring disc-shaped antenna slot which is orthogonal to the longitudinal axis of the fuse and which extends through the outside wall of the ring chamber and opens radially on the one hand inwardly into the ring chamber and on the other hand outwardly through the fuse casing. The axial position of that antenna in the truncated cone of the fuse tip depends in particular on the frequency-determining geometry of the hollow-cylindrical hollow cavity and the ring disc-shaped slot which goes therearound extending radially therefrom. Radially outside that slot antenna there is an antenna characteristic which is in the form of an annular bead in an axially symmetrical configuration, that is to say toric-like, so that once again even upon rotation of the ammunition about its longitudinal axis, there is always at least a portion of the antenna characteristic with a level of sensitivity which remains practically constant, that is to say without modulation phenomena, that detects the half-space above the horizon and thus navigational satellites which are above the horizon.

It has surprisingly been found that such a slot antenna not only has the harmonics to be expected in relation to the resonance frequency which is geometrically governed by the resonator cavity, but independently thereof it also still has a plurality of further marked resonances at frequencies which are higher in relation thereto. These can be tuned in particular by way of the dielectric constant of a dielectric which is introduced into the ring chamber and/or into the slot. In the development of the present invention such tuning is to a radar frequency which is substantially higher than the carrier frequency of a navigational satellite system and which is suitable for fuse proximity triggering but which now however is no longer an integral multiple (not a harmonic) in relation to the navigational carrier frequency.

Thus the same antenna characteristic which concentrically surrounds the longitudinal axis of the fuse in a toric configuration again serves on the one hand for receiving satellite navigation information and on the other hand for emitting and receiving radar signals for the function of distance resolution of a proximity fuse. The radar characteristic thereof is now admittedly no longer directed substantially concentrically forwardly; that however is not a disadvantage because the precisely frontal encounter with the fuse-triggering target, depending on the respective external ballistics, that is to say the position of the fuse in space, is the markedly rarer situation, in comparison with a lateral approach.

For tuning in particular to a second resonance frequency which is shifted in relation to the cavity resonance, introduced into the axially divided resonator cavity of the slot antenna is an electrically insulating ring disc which is very thick in relation to the height of the antenna slot, that is to say a hollow cylinder of a material which is electrically as poorly conducting as possible, with a high dielectric constant in relation to air. Such material is to be distinguished by low dielectric losses and a high level of resistance to tracking current, independently of frequency and temperature, for which reason in particular the fluorine-bearing polymer PTFE (polytetrafluoroethylene) which is marketed under trade names such as Teflon, Fluon or Hostaflon, is suitable for that purpose.

For a practical implementation, besides the actual resonator ring chamber, the antenna slot which goes therearound extending radially therefrom is dielectrically filled, preferably then integrally with the filling of the ring chamber by a collar which extends therearound flange-like externally on the hollow cylinder of the ring chamber and which extends radially as far as the conical peripheral surface of the fuse, to provide for mechanical support and sealing integrity in the slot region.

Thus, for a fuse which can be universally employed for artillery ammunition, the invention provides a slot antenna which can be subjected to mechanically extremely high loadings, by means of a sandwich structure in which a resonator ring chamber axially enclosed between upper and lower metallic cover discs profiled to be stable in respect of shape, is provided with a thick dielectric hollow cylinder for tuning to a second higher resonance frequency. The hollow cylinder extends with a peripherally extending collar radially opposite a central cylindrical reflector wall through an axial slot which extends radially through the outside wall of the ring chamber to the outer frustoconical surface of the correspondingly peripherally slit fuse casing. In this arrangement the mechanical dimensions and electrical properties are predetermined in such a way as to afford two resonance frequencies which are sufficiently far apart for this antenna structure for on the one hand satellite navigation and on the other hand for the function of a radar proximity fuse with the same toric antenna characteristic.

Additional developments and further features and advantages of the invention are set forth in the further claims and the description hereinafter of a preferred embodiment of the structure according to the invention, which is diagrammatically shown in the drawing, being limited to what is essential, in somewhat abstracted form but approximately true to scale. In the drawing:

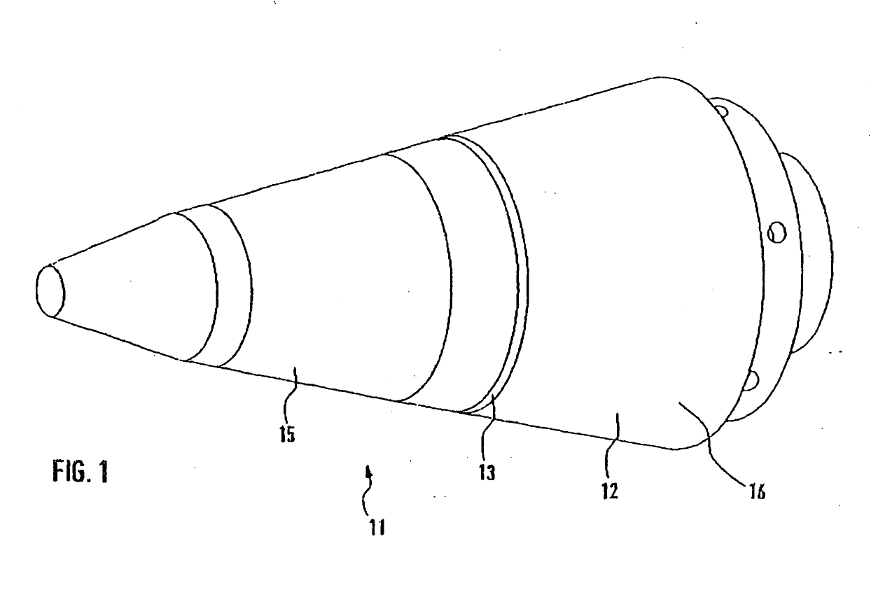

FIG. 1 is an isometric view of the fuse which can be applied to an item of artillery ammunition, with its antenna slot which in this embodiment is disposed between half the axial height and the base plane of the fuse and is filled with dielectric material,

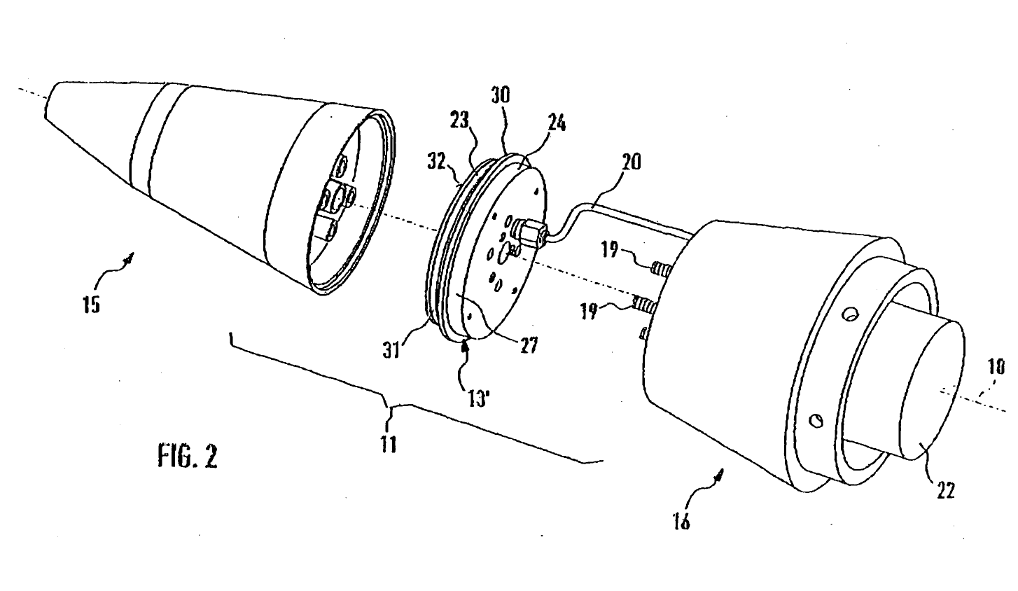

FIG. 2 is a view in the manner of an exploded illustration of the antenna which is axially clamped between the tip and the base of a fuse as shown in FIG. 1, and

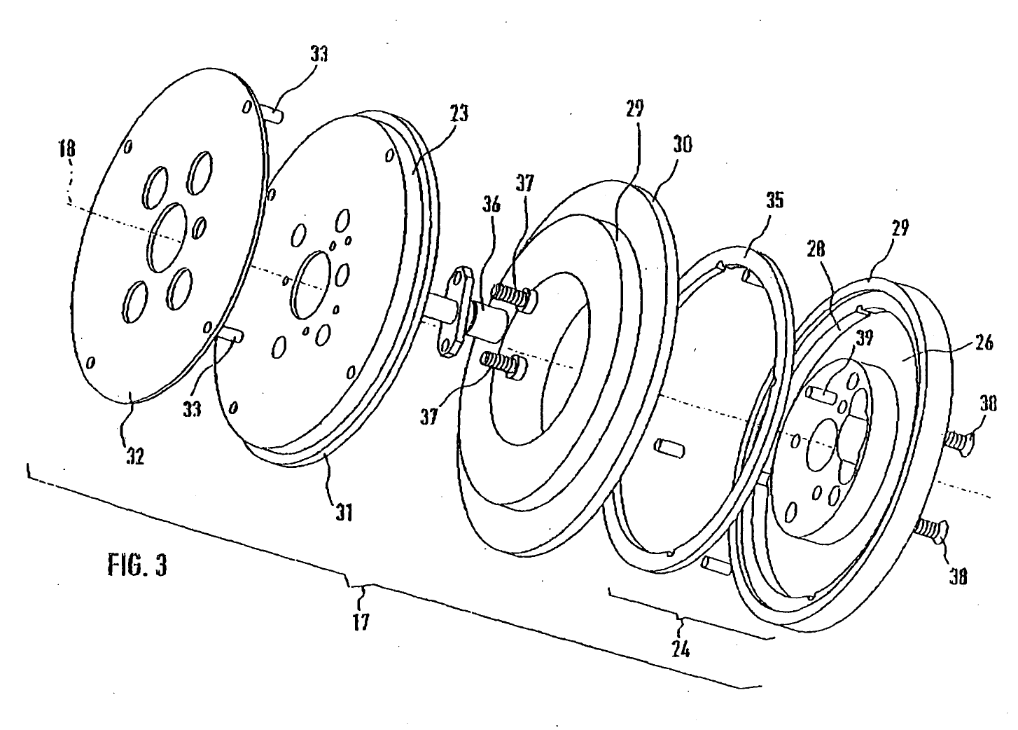

FIG. 3 is a view in the manner of an exploded illustration showing the mechanical sandwich structure of the antenna of FIG. 2.

The head fuse 11 shown in FIG. 1 is intended to be screwed by means of a screwthread (not shown) into the mouth hole in the end of the body of a conically tapering, in particular spin-stabilised item of artillery ammunition. The fuse 11 is provided with an antenna slot 13 which extends radially through its slightly cambered cone wall 12 therearound, the slot 13 being filled with dielectric material which terminates flush with the outside peripheral surface, which adjoins it axially on both sides, of the solid wall 12. Disposed in front of the radial plane of the slot 13, that is to say towards the tip of the front part 15 of the fuse, are mechanical or electromechanically operative safety and triggering devices of the fuse 11 and optionally aerodynamically operative braking devices for reducing the length of the trajectory, as described in the present applicants' earlier application No 199 57 363.8 of 29 Nov. 1999 (to which reference is made herein in respect of the full content thereof to supplement the present disclosure of the invention in terms of a preferred situation of use of the slot antenna for satellite navigation for trajectory tracking and correction). Disposed behind the radial plane of the slot 13, that is to say towards the base of the rear part 16 of the fuse, are electrical circuits for antenna amplification and signal processing of the electromagnetic energy which is received or radiated by way of the slot 13 in the very high frequency spectrum. This involves on the one hand a radar function, that is to say the emission of very high-frequency energy and receiving the target echoes thereof, and on the other hand receiving carriers which are of longer wave in relation thereto for the items of information from navigational satellites with the same slot antenna 17.

As diagrammatically shown in FIG. 2 the front part 15 of the fuse and the rear part 16 of the fuse are connected together with the axial interposition of the antenna 17 which can withstand extremely high mechanical loadings, by means of clamping screws 19 which extend parallel to the longitudinal axis 18 of the fuse and which extend through the antenna 17. A flexible antenna line 20 of coaxial cross-section leads to the antenna amplifier (not shown) disposed in the rear part 16 of the fuse. In the case of a receiving antenna this is a pre-amplifier upstream of the receiver signal processing circuit and in the case of a transmitting antenna this is a power amplifier downstream of the transmitter signal processing circuit; that circuit, like the power supply unit 22 thereof (for example in the form of an activatable battery or an afflux flow generator) is installed in the region of the base of the rear part 16 of the fuse.

It will be seen from the detail view in FIG. 3 that and how the disc-shaped antenna 17 is constructed in a sandwich-like fashion from torsionally stiff components. It substantially comprises two mechanically stiffly profiled metal cover discs, namely a metal upper disc 23 which is disposed towards the front part 15 of the fuse and which is of a shallow cup-shaped rotationally symmetrical profile in plate-like manner, and a metal lower disc 24 which is disposed oriented in the opposite direction thereto towards the rear part 16 of the fuse and which is also of a shallow cup-shaped rotationally symmetrical profile configuration in plate-like manner—but in this case by way of example being in two parts for handling reasons for the connection of the antenna line. Each of those two discs 23-24 has a central stiffening means in the form of a base portion 25 which protrudes axially from the bottom 26 of the cup configuration between the walls 24 and 31 respectively. By virtue of that arrangement, defined radially between those base portions 25 and the hollow-cylindrical walls 27, 31 which extend peripherally at a spacing in relation thereto and axially between the bottoms 26 is a resonator ring chamber 28 which is approximately centrally divided transversely with respect to the longitudinal axis 18, insofar as, with axially mutually spaced end edges of the walls 27-31, the plate-shaped upper disc 23 bears with its base portion in electrically conductive relationship, as it is flat, axially against the face of the base portion 25 in the also plate-shaped lower disc 24. The axially mutually spaced end edges of the walls 27-31 define as between them, in radially opposite relationship to the cylindrical reflector wall of the base portion 25, the actual antenna slot 13′ which extends radially from the ring chamber 28.

As therefore that ring chamber 28 is axially divided, a thick annular disc-shaped hollow cylinder 29 of dielectric material can be inserted therein prior to fitting of the upper disc 23. The cylinder 29 has an externally radially peripherally extending collar 30 which projects in a flange-shaped configuration and of an axial thickness which is slightly smaller in comparison with the ring disc 29. The collar 30 extends radially with respect to the longitudinal axis 18 through the slot 13′ which remains by virtue of the axial height of the base portion 25 between the mutually facing end faces of the walls 27 and 31 which externally enclose the ring chamber 28. The collar 30 preferably even also extends radially through the slot 13′ into the slot 13 in the wall 12 between the front part 15 and the rear part 16 of the fuse, until terminating flush with the immediately adjacent outside peripheral surfaces. That facilitates assembly when axially fitting the front part 15 and the rear part 16 of the fuse together over the antenna 17 and here avoids turbulence in the region of the ogive of the body of the ammunition, which is particularly sensitive in terms of flow dynamics.

In the radial plane in front of the upper disc 23, that is to say towards the front part 15 of the fuse, the antenna 17 is fitted with a dielectric disc 32. That serves as a wiring carrier for the linking network between four mutually orthogonal connections to the inward end, which is towards the ring chamber 28, of the antenna slot 13′. For that purpose, four coaxial conductor portions 33 are anchored in parallel relationship with the longitudinal axis 18 of the system on the disc 32 at the corners of a notional square. The inner conductors pass through the hollow cylinder 29 in order finally to end at a narrow electrically conductive hoop 35. The outer conductors are conductively connected to the upper disc 23 and to the underside of the circuit carrier disc 32. It is a component part of the two-part lower disc 23 and can be inserted into an end opening in the wall 31 thereof in such a way that it defines the rearward inner edge of the slot 13′ which opens towards the annular chamber 28. Firstly however the inner conductor of the coaxial antenna line 20 is connected to that edge of the slot in the form of the hoop 35 when it is still removed from the lower disc 24, more specifically by way of the network provided on the circuit carrier disc 33, for bringing the four contact points which are respectively displaced relative to each other through 90° together at the peripherally extending slot 13′ and by way of the conductor pins by means of a plug connection in the form of a coaxial plug socket 36. Thereafter the lower disc 24 is fitted from the rear over that hoop 35 which is thus already electrically connected through the dielectric hollow cylinder 29 to the circuit carrier disc 32 in front of the upper disc 23.

The front inner edge of the slot which is in axially opposite relationship to the rearward edge is afforded by the inner end edge of the peripherally extending wall 31 of the upper disc 23. The electrical connection thereof to the outer conductor of the antenna line 20 is effected by the coaxial plug socket 36 for the antenna line 20, the ring disc 29 and the lower disc 24 being mounted eccentrically on to the inside of the bottom of the upper disc 23, by means of screws 37, extending therethrough in parallel relationship with the axis, towards the rear part 16 of the fuse, with play.

This sandwich structure for the antenna 17, which is shown in FIG. 3 and which is already in itself mechanically extremely stable, is axially braced together by means of screws 38 coaxially between the antenna lower disc 24 and upper disc 23, with the interposition of the collar 30 which engages radially through the hollow-cylindrical walls 26, 31, and as a result it is additionally torsionally stiff. Posts 39 which are mounted on at least one of the bottom base portions 25 and which extend through the hollow cylinder 29 into the axially opposite disc 23 and 24 respectively serve as an assembly aid when the components are axially brought together and thereafter serve as a means for preventing relative rotational movement as between the upper disc 23 and the lower disc 24, that is to say serve to carry spin-induced rotational forces between those two parts of the cavity resonator of the slot antenna 17.

1. A combination antenna which is integrated into an unscrewable head fuse (11) of an item of artillery ammunition for frequencies which are to be processed in the region of the fuse (11) of a radar proximity fuse and a navigational satellite receiver,
wherein a ring disc-shaped slot antenna (17) which is disposed transversely with respect to the fuse axis opens, respectively, radially outwardly through a conical wall of the fuse and inwardly into a resonator ring chamber (28) having an axial length which is substantially greater than the axial thickness of a slot (13) of the antenna, for operation in addition to the geometrically governed resonance frequency for navigational tasks, at a further resonance frequency for tasks of the radar proximity fuse, said further resonance frequency being determined by the dielectric of an electrically non-conducting hollow cylinder (29) which is introduced into the resonator ring chamber (28) in the absence of representing an integral multiple in relation to the navigational resonance frequency.

2. An antenna according to claim 1, wherein in addition to the actual resonator ring chamber (28), the antenna slot (13) which extends about said chamber and extending radially therefrom is also filled with a dielectric.

3. An antenna according to claim 1, wherein integrally with the filling of the ring chamber (28) in the form of the hollow cylinder (29) is a flange-shaped collar (30) which extends thereabout and which extends radially as far as the conical peripheral wall surface of the fuse (11) through the slot (13).

4. An antenna according to the claim 1, wherein the collar (30) axially fills the slot (13) and terminates flush with the outside surface of the peripherally slit fuse wall (12).

5. An antenna according to claim 1, wherein a frequency-dividing means leads from the slot antenna (17) to a transmitting-receiving unit of a radar fuse.

6. An antenna according to claim 1, wherein a two-wire antenna cable is connected to at least two locations, which are disposed axially one in front of the other, at the inside edges of the slot (13), wherein four such connecting locations are provided at the corners of a notional square concentric with respect to the fuse axis and are brought together by a matching network to the standardized impedance of a coaxial line leading to the antenna amplifier.

7. An antenna according to claim 6, including a dielectric disc (32) which serves as a wiring carrier for the network between the four mutually orthogonal connections to the inner end of the slot (13) which faces towards the ring chamber (28).

8. An antenna according to claim 1, wherein there is provided a circuit carrier disc (32) which has a network for bringing together a plurality of connecting locations disposed along an inner edge of the slot (13′) to a wire of an antenna line (20).

9. An antenna according to claim 8, wherein the inner edge of the slot (13′) is formed by a hoop (35) which is inserted at an end face into one of the hollow-cylindrical walls (27, 31) of the ring chamber (28).
